(19) United States
(12) Patent Application Publication
(10) Pub. No.: US 2026/0217279 A1
(43) Pub. Date: Jul. 30, 2026

(54) AUTONOMOUS DECISION-MAKING CONTROL SYSTEM AND METHOD FOR AVOIDING SECONDARY COLLISION OF VEHICLE

(71) Applicant: TSINGHUA UNIVERSITY, BEIJING (CN)

(72) Inventors: XIAOHUI HOU, BEIJING (CN); JUNZHI ZHANG, BEIJING (CN); CHENGKUN HE, BEIJING (CN); SHIYUE ZHAO, BEIJING (CN)

(21) Appl. No.: 19/147,049

(22) PCT Filed: Oct. 30, 2023
(86) PCT No.: PCT/CN2023/127481

§ 371 Date: Jul. 10, 2025

(30) Foreign Application Priority Data
Jan. 10, 2023 (CN) 202310035159.6

(51) Int. Cl. B60W 60/00; B60W 30/08; B60W 30/09; B60W 50/06; B60W 50/08; B62D 6/00; B62D 15/02

(52) U.S. Cl. CPC B60W 60/0015; B60W 30/09; B60W 50/06; B60W 50/082; B62D 6/003; B62D 15/0265; B60W 2030/082; B60W 2520/06; B60W 2520/14; B60W 2520/26

(57) ABSTRACT

An autonomous decision-making control system for avoiding a vehicle secondary collision includes a control object, a pre-collision steering controller and a post-collision controller. The pre-collision steering controller includes a feedforward steering controller configured to send a first control command to the control object before a collision occurs and when a preset trigger condition is met. The post-collision controller includes a reinforcement learning algorithm based post-collision controller and a rule switching based post-collision controller configure to, after the collision occurs, establish a rule switching based post-collision control strategy according to a current vehicle motion state and an optimization control objective, and optimize network parameters in the reinforcement learning algorithm based post-collision controller to obtain an optimal control strategy, and send a second control command to the control object. The control object is configured to perform an optimization operation on vehicle post-collision control parameters in case of responding to the control commands.

### CROSS-REFERENCE TO RELATED APPLICATIONS

This application is a US national phase application of International Application No. PCT/CN2023/127481, filed on Oct. 30, 2023, which claims a priority to Chinese Patent Application No. 2023100351596, filed on Jan. 10, 2023, the content of which is incorporated herein by reference in its entirety.

### FIELD

The present disclosure relates to the field of visual positioning technology, and more particularly to an autonomous decision-making control system for avoiding a vehicle secondary collision and a method thereof.

### BACKGROUND

Road traffic accidents seriously threaten social economic development and human lives and property safety, and more than 90% of these traffic accidents are caused by driver's operational error. Currently, a vehicle active safety function usually only considers avoiding collisions through a series of operations, without considering stability control after a collision occurs. A collision hit on a vehicle can always accompany with a sudden increase in a yaw rate and a lateral speed. Driver failure to react promptly or improper operation may lead to vehicle instability and deviation from its original trajectory, resulting in secondary collisions or even multiple collisions. These collision incidents pose significantly higher risks of severe injuries than single-collision incidents and can result in severe casualties and significant losses.

In order to stabilize a vehicle motion state after the collision occurs, Volkswagen of Germany has developed a multiple collision prevention system. When an airbag control unit recognizes a first collision of the vehicle, the function will be activated and automatically perform emergency braking to reduce a speed of the vehicle to 10 km/h as soon as possible, thereby avoiding or alleviating the secondary collision to a certain extent. However, considering drastic changes in the yaw rate and the lateral speed of the vehicle after the collision occurs, a simple braking strategy cannot effectively reduce the risk of the secondary collision, because a braking operation does not directly control stability of the vehicle, and decays of the yaw rate and the lateral speed are just a side effect of reduction in speed of the vehicle. In addition, relying solely on an electronic stability controller (ESC) system is also difficult to meet engineering requirements of avoiding secondary collisions after the collision of the vehicle, because the ESC can only ensure lateral motion stability of the vehicle within a certain disturbance range, and cannot effectively reduce a lateral displacement deviation and a heading angle deviation between the vehicle and a target path. Therefore, it is still possible to cause the secondary collision with a vehicle in an adjacent lane, especially when the vehicle body deflects 90° and collides with other vehicles laterally, which will lead to more serious accidents.

Dynamic model strategy adopted in existing research is often too ideal and cannot reflect complex characteristics of the vehicle under an extreme driving condition. In fact, for different natures and degrees of collisions and at different stages after the collision, a primary optimization objective of the vehicle changes accordingly. However, evaluation indicators of current research are too simplified and scattered, lacking mechanism analysis and system integration of vehicle safety performance indicators under the extreme driving condition, making it difficult to achieve comprehensive optimization of an entire control process.

### SUMMARY

In an aspect of the present disclosure, there is provided an autonomous decision-making control system for avoiding a vehicle secondary collision. The system includes a control object, a pre-collision steering controller and a post-collision controller, in which,
the pre-collision steering controller includes a feedforward steering controller, in which, the feedforward steering controller is configured to send a first control command to the control object before a collision occurs and when a preset trigger condition is met;
the post-collision controller includes a rule switching based post-collision controller and a reinforcement learning algorithm based post-collision controller, in which, the rule switching based post-collision controller is configure to, after the collision occurs, establish a rule switching based post-collision control strategy according to a current vehicle motion state and an optimization control objective, and optimize network parameters in the reinforcement learning algorithm based post-collision controller to obtain an optimal control strategy, and send a second control command to the control object; and
the control object is configured to perform an optimization operation on vehicle post-collision control parameters in case of responding to the first control command and the second control command.

In another aspect of the present disclosure, there is provided an autonomous decision-making control method for avoiding a vehicle secondary collision. The method includes:
obtaining a first control command before a collision occurs and when a preset trigger condition is met;
after the collision occurs, establishing a rule switching based post-collision control strategy according to a current vehicle motion state and an optimization control objective, and optimizing network parameters to obtain an optimal control strategy, and generating a second control command; and
performing the first control command and the second control command to optimize vehicle post-collision control parameters.

In another aspect of the present disclosure, there is provided a non-transitory computer readable storage medium having a computer program stored thereon. When the program is executed by a processor, the autonomous decision-making control method for avoiding a vehicle secondary collision is implemented. The method includes:
obtaining a first control command before a collision occurs and when a preset trigger condition is met;
after the collision occurs, establishing a rule switching based post-collision control strategy according to a current vehicle motion state and an optimization control objective, and optimizing network parameters to obtain an optimal control strategy, and generating a second control command; and
performing the first control command and the second control command to optimize vehicle post-collision control parameters.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a schematic diagram illustrating an autonomous decision-making control system for avoiding a vehicle secondary collision according to an embodiment of the present disclosure.

FIG. 2 is a flow chart illustrating an autonomous decision-making control method for avoiding a vehicle secondary collision according to an embodiment of the present disclosure.

### DETAILED DESCRIPTION

It should be noted that, without conflict, embodiments of the present disclosure and features in embodiments can be combined with each other. Reference will be made in detail to embodiments of the present disclosure with reference to the accompanying drawings and embodiments.

In order to facilitate a better understanding of the present disclosure by those skilled in the art, descriptions will be made clearly and completely on the technical solutions in embodiments of the present disclosure, in combination with the accompanying drawings in embodiments of the present disclosure. Obviously, the described embodiments are only a part of embodiments of the present disclosure, not all embodiments. Based on embodiments in the present disclosure, all other embodiments obtained by those ordinary skilled in the art without creative labor shall fall within the scope of protection of the present disclosure.

An autonomous decision-making control system for avoiding a vehicle secondary collision and a method thereof according to embodiments of the present disclosure are described below with reference to the accompany drawings.

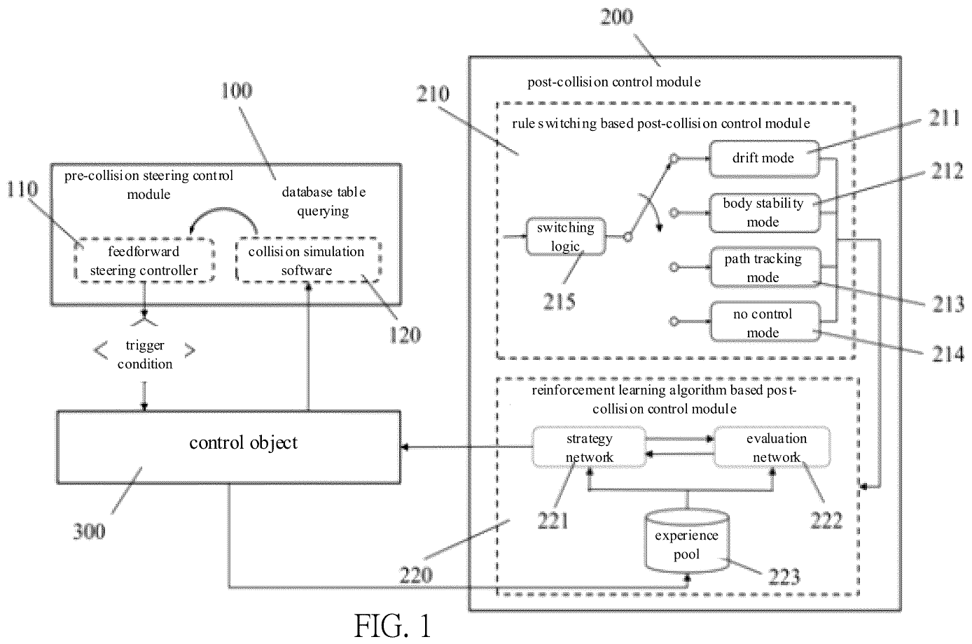

FIG. 1 is a schematic diagram illustrating an autonomous decision-making control system for avoiding a vehicle secondary collision according to an embodiment of the present disclosure.

As illustrated in FIG. 1, the system includes a pre-collision steering control module 100, a post-collision control module 200, a rule switching based post-collision control module 210, a reinforcement learning algorithm based post-collision control module 220, a control object 300, a feedforward steering controller 110, a collision simulation software 120, a drift mode 211, a body stability mode 212, a path tracking mode 213, a no control mode 214, a switching logic 215, a strategy network 221, an evaluation network 222, and an experience pool 223.

In an embodiment, before a collision occurs and when a trigger condition is met, the feedforward steering controller 110 of the pre-collision steering control module 100 sends a control command to the control object 300. After the collision occurs, the post-collision control module 200 starts to work, and the reinforcement learning algorithm based post-collision control module 220 initializes its network parameters by tracking a control strategy obtained by the rule switching based post-collision control module 210 in an early stage of algorithm training, thereby avoiding random disorder of a reinforcement learning algorithm in an early stage of strategy exploration. On the basis of this, the reinforcement learning algorithm based post-collision control module 220 further explores and obtains an optimal control solution. The evaluation network 222 improves a sampling efficiency by learning a value function, and the strategy network 221 learns a strategy function and sends a control command to the control object 300. The control object 300 stores a state transfer element in the experience pool 223 for subsequent random sampling and network update.

Furthermore, each control mode 211-214 in the rule switching based post-collision control module 210 may be applied with different control algorithms, which may be selected according to actual conditions.

Furthermore, the reinforcement learning algorithm based post-collision control module 220 can select and improve different types of reinforcement learning algorithms according to actual conditions.

Furthermore, the pre-collision steering control module 100 counteracts and offsets body slip and rotation caused by the collision by taking reverse feedforward steering control in advance before the collision occurs, thereby effectively suppressing a sharp increase of a yaw rate and a heading angle of the vehicle caused by the collision at its roots, and reducing a difficulty of control after the collision.

The rule switching based post-collision control module 210 establishes a rule switching based post-collision control strategy according to a current vehicle motion state and a primary optimization control objective. The strategy obtained by the rule switching based post-collision control module 210 may be used as prior knowledge to initialize the network parameters of the reinforcement learning algorithm based post-collision control module 220, such that the reinforcement learning algorithm can quickly converge to a more reasonable direction in an early stage of strategy exploration.

The reinforcement learning algorithm based post-collision control module 220 further explores and obtains the optimal control strategy on the basis of the rule switching based post-collision control module 210. By means of in-depth mechanism analysis of the vehicle motion state and systematic integration of various optimization indicators after the collision occurs, comprehensive optimization of an entire control process after the vehicle occurs the collision is achieved.

It is understandable that the control object 300 is configured to perform an optimization operation on vehicle post-collision control parameters in case of responding to a first control command sent by the feedforward steering controller 110 and a second control command sent by the strategy network 221 by learning a strategy function.

In some embodiments, the pre-collision steering control module 100 obtains relative position information and relative speed information of an own vehicle and another vehicle based on a vehicle perception system, and within a limited time before predicting that the collision is about to occur, generates a yaw moment in an opposite direction by taking feedforward steering control in advance to counteract and offset the body slip and rotation caused by the collision. In order to obtain an optimal feedforward steering angle corresponding to a current collision condition, accident simulations are performed on different collision conditions and different feedforward steering operations under respective conditions based on collision simulation analysis software, and a collision database is established by acquiring relevant data. Assumed that the vehicle performs the feedforward steering operation T seconds in advance before the collision, the optimal feedforward steering angle corresponding to the current collision condition can be obtained by querying a table based on the collision database, so that absolute values of the yaw rate and the heading angle of a front vehicle at an initial time point after the collision are minimized, that is,

$${min}_{{δ}_{f}} J = \vert {r}_{0} \vert + \vert {Φ}_{0} \vert ,$$

where J is a loss function of feedforward control, δ_{f} is a front wheel steering angle of the vehicle in feedforward steering control, and r₀ and Φ₀ are the yaw rate and the heading angle of the vehicle at the initial time point after the collision.

In some embodiments, the rule switching based post-collision control module 210 is classified with four control modes according to different natures and degrees and different stages after the collision. The control modes classified include, but are not limited to, the following modes: (1) a drift mode, (2) a body stability mode, (3) a path tracking mode, and (4) a no control mode. A control output is a desired front wheel steering angle, a desired left rear wheel longitudinal slip rate and a desired right rear wheel longitudinal slip rate of the vehicle. The present disclosure also designs a criteria for switching between respective control modes. A control strategy and a switching logic of each control mode may be introduced in detail below.

Drift mode: in an early stage after the collision, a dynamic control boundary of the vehicle chassis system is expanded to the maximum extent by using such aggressive driving technique of drifting, thereby effectively suppressing a rapid increase of a center of mass slip angle, a heading angle and a lateral displacement caused after the collision occurs. In a drift control mode, the vehicle turns with full force, and a direction of the front wheel steering angle is opposite to a direction of an initial yaw rate after the collision. Two rear axle wheels are in an adhesion saturation state, and provide maximum longitudinal forces in opposite directions respectively under a limitation of a friction circle, such that the vehicle may adjust a body yaw and slip motion to the greatest extent under the yaw moment generated by a combined action of a lateral force and a longitudinal force.

(2) Body stability mode: when stabilizing the body motion state becomes a current primary optimization objective of the vehicle, a body stability control mode is activated. A working principle of the body stability control mode is similar to a working principle of ESC (electronic stability controller), which generates the yaw moment by applying longitudinal forces in opposite directions to the left rear wheel and the right rear wheel, thereby stabilizing the yaw rate of the vehicle body.

(3) Path tracking mode: when reducing a lateral displacement deviation and a heading angle deviation between the vehicle and a target path becomes the current primary optimization objective, a path tracking control mode is activated. A vehicle path tracking control strategy is designed for this path tracking control mode, which ensures lateral stability of the vehicle while making the lateral displacement deviation and the heading angle deviation approach 0.

(4) No control mode: when the lateral displacement deviation, the heading angle deviation, and a body posture of the vehicle are stable within a certain range, the vehicle may continue to drive in the original lane in a direction of movement before the collision and achieve a final control objective. At this time, the no control mode is activated and no control operation is applied.

(5) Mode switching logic: a controller determines a current control mode based on the current lateral displacement deviation, the heading angle deviation, the yaw rate, and a center of mass sideslip angle of the vehicle and applies control correspondingly. A switching logic between respective control modes is shown in FIG. 1.

In some embodiments, the reinforcement learning algorithm based post-collision control module 220 further explores to obtain a post-collision control optimal control solution on the basis of the rule switching based post-collision control module 210 with combining the reinforcement learning algorithm, and trains on a vehicle simulation platform. The reinforcement learning algorithm based post-collision control module 220 is further configured to systematically integrate and model multiple optimization indicators in the form of a reward function, which solves the problem of single optimization objective in the rule switching based post-collision control module 210 and difficulty in achieving comprehensive optimization. A specific design of the reinforcement learning algorithm in the module will be introduced below.

(1) State space: a state space Sᵣ includes motion state information of the vehicle after the collision occurs and control strategy reference information of the rule switching based post-collision control module, which is formulated as:

$$\begin{matrix}{S}_{r} = {[ {x}_{e} , {x}_{b} ]}^{T} , \\ {x}_{e} = {[ X , Y , ψ , {V}_{x} , {V}_{y} , \dot{ψ} , {a}_{x} , {a}_{y} ]}^{T} , \\ {x}_{b} = {[ M , {δ}^{rule} , {s}_{x 3}^{rule} , {s}_{x 4}^{rule} ]}^{T} ,\end{matrix}$$

where xₑ and x_{b} are vehicle state information and control strategy information based on rule switching, respectively, Vₓ, V_{y} and \dot{ψ} are a longitudinal velocity, a lateral velocity and a yaw rate of an own vehicle in a vehicle coordinate system, respectively, (X, Y) and ψ are a center of mass position and a yaw angle of the own vehicle in a geodetic coordinate system, respectively, aₓ and a_{y} are a longitudinal acceleration and a lateral acceleration of the vehicle, respectively, M is a control mode of a rule-based controller corresponding to a current state, the control modes include four modes such as (1) drift mode, 2) body stability mode, 3) path tracking mode, 4) no control mode, etc., δᵣᵤₗₑ,

$${s}_{x 3}^{rule} , {s}_{x 4}^{rule}$$

are desired values of a front wheel steering angle, a left rear wheel longitudinal slip ratio and a right rear wheel longitudinal slip ratio output by the rule-based controller, respectively.

(2) Action space: the action space includes the following three elements:

$${A}_{r} = {[ {δ}_{d} , {s}_{x 3}^{d} , {s}_{x 4}^{d} ]}^{T} ,$$

where δ_{d} is a desired front wheel steering angle of an own vehicle,

$${s}_{x 3}^{d} and {s}_{x 4}^{d}$$

are a desired left rear wheel longitudinal slip ratio and a desired right rear wheel longitudinal slip ratio of the own vehicle.

(3) Reward function:

\textcircled{1} Immediate reward: (a) path tracking term: a path tracking term Rᵣᵢ₁ is used to encourage the vehicle to reduce the lateral displacement deviation and the heading angle deviation from the target path during a control process after the collision, causing the vehicle to return to a motion direction before the collision as soon as possible and continue to drive in an original lane, thereby reducing a possibility of the secondary collision with vehicles in other lanes. Rᵣᵢ₁ is defined as:

$${R}_{ri 1} = {k}_{r 1} \cdot \vert {e}_{Y} \vert + {k}_{r 2} \cdot \vert {e}_{φ} \vert ,$$

where e_{Y} is a deviation between an actual lateral displacement and a reference lateral displacement of the vehicle, e_{φ} is a deviation between an actual heading angle and a reference heading angle of the vehicle, kᵣ₁ and kᵣ₂ are negative constants, which are reward weights configured to adjust a lateral displacement deviation and a heading angle deviation, respectively.
(b) Body stability term: the body stability term Rᵣᵢ₂ is configured to encourage the vehicle to maintain a stable motion state during the control process to prevent the excessive yaw rate and center of mass sideslip angle due to large impact of the collision or excessive adjustment after the collision, and to avoid deterioration of the body stability. Therefore, Rᵣᵢ₂ is defined as:

$${R}_{ri 2} = {k}_{r 3} \cdot ( \vert \dot{ψ} \vert + \vert β \vert ) ,$$

where kᵣ₃ is a negative constant, which is a reward weight configured to adjust absolute value of a yaw rate ψ and a center of mass sideslip angle β.
(c) Rollover risk item: the present disclosure does not involve a situation where the vehicle occurs rollover, but the control process still considers reducing a risk of vehicle rollover. A lateral load transfer ratio (LTR) is taken as a vehicle rollover risk index, which is defined as:

$$LTR = \frac{\vert {F}_{z 1} + {F}_{z 3} - {F}_{z 2} - {F}_{z 4} \vert}{{F}_{z 1} + {F}_{z 2} - {F}_{z 3} - {F}_{z 4}} ,$$

where F_{zi}(i=1,2,3,4) are vertical loads of a left front wheel, a right front wheel, a left rear wheel, a right rear wheel of the vehicle respectively. As can be seen from formula (5-24), when LTR=0, no lateral load transfer occurs; when LTR=1, the wheels just leave the ground; when LTR>1, the vehicle occurs rollover. A safety threshold of the LTR is set as LTRₜ+=0.8, and Rᵣᵢ₃ is defined as:

$${R}_{ri 3} = \{ \begin{matrix}0 & LTR \leq {LTR}_{t} \\ {k}_{r 4} \cdot ( LTR - {LTR}_{t} ) & LTR > {LTR}_{t}\end{matrix} ,$$

where LTRₜ is a safety threshold of a lateral load transfer ratio, kᵣ₄ is a negative constant, which is a reward weight configured to adjust the rollover risk term. During vehicle driving, when the LTR is less than or equal to the safety threshold, Rᵣᵢ₃ is set as 0; when the LTR is greater than the safety threshold, a corresponding penalty is given according to a degree of deviation from the safety threshold.
(d) Input size and change rate term: the size of an actual control input [δ, Sₓ₃, Sₓ₄]^{T} of an agent and its change rate are negatively correlated with the reward. The smaller the input size and its change rate, the easier it is for the vehicle to stay in a linear stable region and the vehicle is not prone to instability. Rᵣᵢ₄ is defined as:

$${R}_{ri 4} = {k}_{r 5} \cdot ( {δ}^{2} + {s}_{x 3}^{2} + {s}_{x 4}^{2} ) + {k}_{r 6} \cdot ( {\dot{δ}}^{2} + {\dot{s}}_{x 3}^{2} + {\dot{s}}_{x 4}^{2} ) ,$$

where kᵣ₅ and kᵣ₆ are negative constants, which are reward weights configured to adjust input items and change rates of the input items, respectively;

The final immediate reward Rᵣᵢ is a sum of the above items Rᵣᵢ₁ to Rᵣᵢ₄.

\textcircled{2} Termination state reward Rᵣₜ: when vehicle collision control is in a termination state, a training round ends, and the termination state reward may be given based on different state modes of the own vehicle. The termination state may include three ending modes, namely, occurrence of rollover, completion of a control objective, and failure to complete the control objective within a certain time period.

$$\{ \begin{matrix}{R}_{rt} = \\ {k}_{r 7} in case of occurence of rollover \\ {R}_{rtc} in case of completion of a control objective \\ {R}_{rtn} in case of failure to complete the control objective until t = {t}_{end}\end{matrix} ,$$

where kᵣ₇ is a negative constant. A larger penalty is given when the vehicle occurs the rollover during the control process after the collision.

Completing the control objective means that, after the collision, the vehicle body reaches a stable state after the collision and a lateral displacement and a heading angle are restored to an initial state before the collision. A determination condition of completing the control objective is consistent with the no control mode in a rule switching based controller, then the control objective is completed. A reward given to the agent is R_{rtc}, and a size of the reward reflects an overall control effect of the vehicle after the collision occurs, which depends on a combination of a plurality of factors, including a maximum lateral displacement distance |Y|ₘₐₓ of the vehicle body during the control process, a control time period t_{c}, and a longitudinal displacement distance |X|ₘₐₓ traveled by the vehicle during the control process. R_{rtc} is defined as:

$${R}_{rtc} = {k}_{r 8} \cdot {\vert Y \vert}_{max} + {k}_{r 9} \cdot {t}_{c} + {k}_{r 10} \cdot {\vert X \vert}_{max} ,$$

where kᵣ₈, kᵣ₉ and kᵣ₁₀ are negative constants, which are configured to adjust reward weights of |Y|ₘₐₓ, t_{end}, and |X|ₘₐₓ, respectively. The smaller the maximum lateral displacement distance |Y|ₘₐₓ of the vehicle body during the control process, the shorter control time period t_{c}, and the smaller the longitudinal displacement distance |X|ₘₐₓ traveled by the vehicle during the control process, the greater the reward value.

In a case where the vehicle has not yet completed the control objective following a certain time period t_{end} of control, this round of training is stopped, and the termination state reward Rᵣₜₙ is defined as:

$${R}_{rtn} = {k}_{r 11} + {k}_{r 8} \cdot {\vert Y \vert}_{end} + {k}_{r 12} \cdot {\vert ϕ \vert}_{end} ,$$

where the reward function Rᵣₜₙ includes a basic penalty portion kᵣ₁₁ and a termination state portion (kᵣ₈·|Y|_{end}+kᵣ₁₂·|Φ|_{end}), where kᵣ₁₁ and kᵣ₁₂ are negative constants, which are configured to adjust reward weights of a basic penalty and a final heading angle |Φ|_{end}, respectively, and kᵣ₈ is configured to adjust a reward weight of the final lateral displacement distance |Y|_{end}.

Combining all the above factors, the agent reward function Rᵣ is finally obtained, which is expressed as a sum of the immediate reward Rᵣᵢ and the termination state reward Rᵣₜ, namely,

$${R}_{r} = {R}_{ri} + {R}_{rt} .$$

Therefore, in real-life scenario, after the collision is hit on the vehicle, it is easy to result in secondary collisions or even multiple collisions. These collision incidents pose significantly higher risks of severe injuries than single-collision incidents and can result in severe casualties and significant losses. Currently, a vehicle active safety system and related research usually only considers avoiding collisions through a series of operations, without considering stability control after the collision occurs. In addition, a collision prediction model adopted in existing research often make a large number of additional assumptions and simplified processing, and evaluation indicators of the current research are too simplified and scattered, making it difficult to achieve a disadvantage of comprehensive optimization of the entire control process. In this regard, the present disclosure proposes the autonomous decision-making control system for avoiding a vehicle secondary collision, capable of mitigating initial collision damage to the greatest extent, while ensuring vehicle body stability after a collision and quickly restoring a vehicle to its initial state before the collision, thereby reducing a risk of occurring a secondary collision and chain collisions after the collision of the vehicle and improving a safety performance of the vehicle.

Furthermore, development of the autonomous driving technology has put forward new requirements for a vehicle active safety function, and also provided a platform and technical support for further improving a vehicle active safety performance under extreme working conditions. The autonomous decision-making control system for avoiding the vehicle secondary collision provided by the present disclosure will be used more and more for years to come, and the present disclosure has a broad application prospect.

The present disclosure proposes the autonomous decision-making control system for avoiding a vehicle secondary collision, capable of ensuring vehicle body stability after the collision and quickly restoring the vehicle to its initial state before the collision, thereby reducing a risk of occurring the secondary collision and chain collisions after the collision of the vehicle and improving a safety performance of the vehicle.

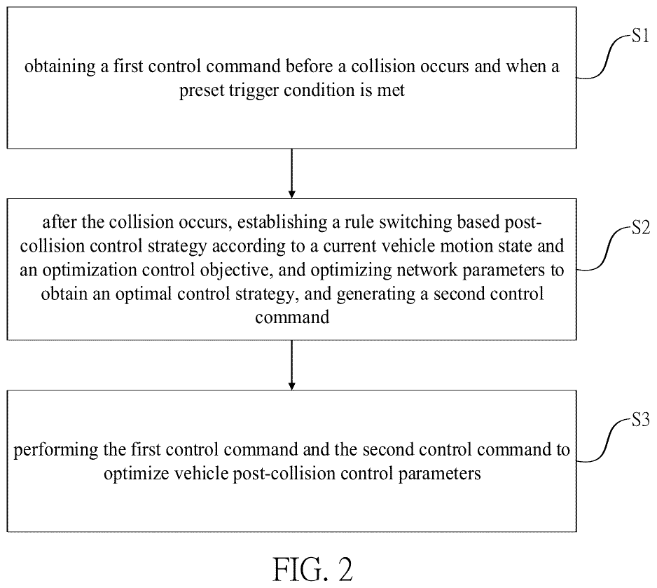

In order to implement the above embodiments, as shown in FIG. 2, this embodiment also provides an autonomous decision-making control method for avoiding a vehicle secondary collision, and the method includes blocks S1-S3.

At block S1, a first control command is obtained before a collision occurs and when a preset trigger condition is met.

At block S2, after the collision occurs, a rule switching based post-collision control strategy is established according to a current vehicle motion state and an optimization control objective, and network parameters are optimized to obtain an optimal control strategy, and a second control command is generated.

At block S3, the first control command and the second control command are performed to optimize vehicle post-collision control parameters.

According to the autonomous decision-making control method for avoiding the vehicle secondary collision in the embodiment of the present disclosure, it is possible to mitigate initial collision damage to the greatest extent, while ensuring vehicle body stability after a collision and quickly restoring a vehicle to its initial state before the collision, thereby reducing a risk of occurring a secondary collision and chain collisions after the collision of the vehicle and improving a safety performance of the vehicle.

An embodiment of the present disclosure also provides an electronic device.

The electronic device includes: a memory, a processor, and a computer program stored in the memory and executable on the processor. The processor is configured to implement the autonomous decision-making control method for avoiding a vehicle secondary collision as described in the above embodiment when executing the computer program.

An embodiment of the present disclosure also provides a non-transitory computer readable storage medium having a computer program stored thereon. When the program is executed by a processor, the autonomous decision-making control method for avoiding a vehicle secondary collision as described in the above embodiment is implemented.

An embodiment of the present disclosure also provides a computer program product. The computer program product includes a computer program, which, when executed by a processor, causes the processor to implement the autonomous decision-making control method for avoiding a vehicle secondary collision as described in the above embodiment.

An embodiment of the present disclosure also provides a computer program. The computer program includes computer program codes, which when running on a computer, causes a computer to implement the autonomous decision-making control method for avoiding a vehicle secondary collision as described in the above embodiment.

It should be noted that the aforementioned explanation of the embodiments of the autonomous decision-making control system for avoiding the vehicle secondary collision and the method thereof also applies to the electronic device, non-transitory computer readable storage medium, the computer program product and the computer program in embodiments of the present disclosure, which will not be repeated herein.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. In addition, those skilled in the art may combine and integrate different embodiments or examples described in the description, as well as features of different embodiments or examples, without conflicting with each other.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, unless specified otherwise.

1. An autonomous decision-making control system for avoiding a vehicle secondary collision, comprising: a control object, a pre-collision steering controller and a post-collision controller, wherein,
the pre-collision steering controller comprises a feedforward steering controller, wherein the feedforward steering controller is configured to send a first control command to the control object before a collision occurs and when a preset trigger condition is met;
the post-collision controller comprises a rule switching based post-collision controller and a reinforcement learning algorithm based post-collision controller, wherein the rule switching based post-collision controller is configure to, after the collision occurs, establish a rule switching based post-collision control strategy according to a current vehicle motion state and an optimization control objective, and optimize network parameters in the reinforcement learning algorithm based post-collision controller to obtain an optimal control strategy, and send a second control command to the control object; and
the control object is configured to perform an optimization operation on vehicle post-collision control parameters in case of responding to the first control command and the second control command.

2. The system according to claim 1, wherein the reinforcement learning algorithm based post-collision controller comprises a strategy network, an evaluation network and an experience pool;
the evaluation network is configured to obtain a sampling efficiency threshold based on a value function, the strategy network is configured to adopt a strategy function and send the second control command to the control object, and the control object is configured to store a generated state transfer element in the experience pool.

3. The system according to claim 1, wherein the pre-collision steering controller further comprises a collision simulation analysis portion,
the pre-collision steering control portion is configured to generate the first control command according to vehicle position information and vehicle speed information obtained based on a vehicle perception system, wherein the first control command comprises a feedforward steering control instruction; and
the collision simulation analysis portion is configured to construct a collision database according to analysis results of different collision condition data, to obtain an optimal feedforward steering angle based on the collision database.

4. The system according to claim 1, wherein the rule switching based post-collision controller comprises a control mode portion and a mode logic switching portion;
the control mode portion comprises control modes of a rule-based controller, the mode logic switching portion is configured for the controller to determine a current control mode and output vehicle control parameters based on a current lateral displacement deviation, a heading angle deviation, a yaw rate and a center of mass sideslip angle of a vehicle; wherein the control modes comprise a drift mode, a body stability mode, a path tracking mode and a no control mode.

5. The system according to claim 1, wherein the reinforcement learning algorithm based post-collision controller is further configured to systematically integrate and model multiple optimization indicators based on a reward function, comprising:
a state space Sᵣ comprising motion state information of a vehicle after the collision and control strategy reference information of the rule switching based post-collision controller, which is formulated as:
$$\begin{matrix}{S}_{r} = {[ {x}_{e} , {x}_{b} ]}^{T} \\ {x}_{e} = {[ X , Y , ψ , {V}_{x} , {V}_{y} , \dot{ψ} , {a}_{x} , {a}_{y} ]}^{T} \\ {x}_{b} = {[ M , {δ}^{rule} , {s}_{x 3}^{rule} , {s}_{x 4}^{rule} ]}^{T}\end{matrix}$$
where xₑ and x_{b} are vehicle state information and control strategy information based on rule switching, respectively, Vₓ, V_{y} and \dot{ψ} are a longitudinal velocity, a lateral velocity and a yaw rate of an own vehicle in a vehicle coordinate system, respectively, (X, Y) and ψ are a center of mass position and a yaw angle of the own vehicle in a geodetic coordinate system, respectively, aₓ and a_{y} are a longitudinal acceleration and a lateral acceleration of the vehicle, respectively, M is a control mode of a rule-based controller corresponding to a current state, δ^{rule},
$${s}_{x 3}^{rule} , {s}_{x 4}^{rule}$$
are desired values of a front wheel steering angle, a left rear wheel longitudinal slip ratio and a right rear wheel longitudinal slip ratio output by the rule-based controller, respectively.

6. The system according to claim 5, wherein systematically integrating and modeling the multiple optimization indicators based on the reward function further comprises:
a preset action space comprising three elements:
$${A}_{r} = {[ {δ}_{d} , {s}_{x 3}^{d} , {s}_{x 4}^{d} ]}^{T}$$
where δ_{d} is a desired front wheel steering angle of an own vehicle,
$${s}_{x 3}^{rule} and {s}_{x 4}^{rule}$$
are a desired left rear wheel longitudinal slip ratio and a desired right rear wheel longitudinal slip ratio of the own vehicle.

7. The system according to claim 6, wherein systematically integrating and modeling the multiple optimization indicators based on the reward function further comprises: obtaining an immediate reward Rᵣᵢ of the reward function;
wherein a path tracking term Rᵣᵢ₁ is defined as:
$${R}_{ri 1} = {k}_{r 1} \cdot \vert {e}_{Y} \vert + {k}_{r 2} \cdot \vert {e}_{φ} \vert$$
where e_{Y} is a deviation between an actual lateral displacement and a reference lateral displacement of the vehicle, e_{φ} is a deviation between an actual heading angle and a reference heading angle of the vehicle, kᵣ₁ and kᵣ₂ are negative constants, which are reward weights configured to adjust a lateral displacement deviation and a heading angle deviation, respectively;
a body stability term Rᵣᵢ₂ is defined as:
$${R}_{r i 2} = {k}_{r 3} \cdot ( \vert \dot{ψ} \vert + \vert β \vert )$$
where kᵣ₃ is a negative constant, which is a reward weight configured to adjust absolute value of a yaw rate ψ and a center of mass sideslip angle β;
a rollover risk term Rᵣᵢ₃ is defined as:
$${R}_{r i 3} = \{ \begin{matrix}0 & LTR \leq {LTR}_{t} \\ {k}_{r 4} \cdot ( LTR - {LTR}_{t} ) & LTR > {LTR}_{t}\end{matrix}$$
where LTRₜ is a safety threshold of a lateral load transfer ratio, kᵣ₄ is a negative constant, which is a reward weight configured to adjust the rollover risk term;
an input size and change rate term Rᵣᵢ₄ is defined as:
$${R}_{r i 4} = {k}_{r 5} \cdot ( {δ}^{2} + {s}_{x 3}^{2} + {s}_{x 4}^{2} ) + {k}_{r 6} \cdot ( {\dot{δ}}^{2} + {\dot{s}}_{x 3}^{2} + {\dot{s}}_{x 4}^{2} )$$
where kᵣ₅ and kᵣ₆ are negative constants, which are reward weights configured to adjust input items and change rates of the input items, respectively;
wherein the immediate reward Rᵣᵢ is a sum of the above items Rᵣᵢ₁ to Rᵣᵢ₄.

8. The system according to claim 7, wherein the system is further configured to obtain a termination state reward Rᵣₜ of the reward function, which is formulated as:
$${R}_{r t} = \{ \begin{matrix}{k}_{r 7} & in case of occurrence of rollover \\ {R}_{rtc} & in case of completion of a control objective \\ {R}_{rtn} & in case of failure to complete the control objective until t = {t}_{end}\end{matrix}$$
$$where {k}_{r 7} is a negative constant .$$

9. The system according to claim 8, wherein an agent reward function Rᵣ is obtained based on the immediate reward Rᵣᵢ and the termination state reward Rᵣₜ, which is formulated as:
$${R}_{r} = {R}_{r i} + {R}_{rt} .$$

10. An autonomous decision-making control method for avoiding a vehicle secondary collision, comprising:
obtaining a first control command before a collision occurs and when a preset trigger condition is met;
after the collision occurs, establishing a rule switching based post-collision control strategy according to a current vehicle motion state and an optimization control objective, and optimizing network parameters to obtain an optimal control strategy, and generating a second control command; and
performing the first control command and the second control command to optimize vehicle post-collision control parameters.

11. (canceled)

12. A computer-readable storage medium having a computer program stored thereon, wherein, when the program is executed by a processor, the autonomous decision-making control method for avoiding a vehicle secondary collision is implemented, wherein the method comprises:
obtaining a first control command before a collision occurs and when a preset trigger condition is met;
after the collision occurs, establishing a rule switching based post-collision control strategy according to a current vehicle motion state and an optimization control objective, and optimizing network parameters to obtain an optimal control strategy, and generating a second control command; and
performing the first control command and the second control command to optimize vehicle post-collision control parameters.

13. (canceled)

14. (canceled)

15. The method according to claim 10, further comprising:
obtaining, by an evaluation network, a sampling efficiency threshold based on a value function;
adopting, by a strategy network, a strategy function and sending the second control command to the control object; and
storing a generated state transfer element in an experience pool.

16. The method according to claim 10, further comprising:
generating the first control command according to vehicle position information and vehicle speed information obtained based on a vehicle perception system, wherein the first control command comprises a feedforward steering control instruction; and
constructing a collision database according to analysis results of different collision condition data, to obtain an optimal feedforward steering angle based on the collision database.

17. The method according to claim 10, further comprising:
determining a current control mode and outputting vehicle control parameters based on a current lateral displacement deviation, a heading angle deviation, a yaw rate and a center of mass sideslip angle of a vehicle; wherein control modes comprise a drift mode, a body stability mode, a path tracking mode and a no control mode.

18. The method according to claim 10, further comprising:
systematically integrating and modeling multiple optimization indicators based on a reward function, comprising:
a state space Sᵣ comprising motion state information of a vehicle after the collision and control strategy reference information of the rule switching based post-collision controller, which is formulated as:
$${S}_{r} = {[ {x}_{e} , {x}_{b} ]}^{T}$$
$${x}_{e} = {[ X , Y , ψ , {V}_{x} , {V}_{y} , \dot{ψ} , {a}_{x} , {a}_{y} ]}^{T}$$
$${x}_{b} = {[ M , {δ}^{rule} , {s}_{x 3}^{rule} , {s}_{x 4}^{rule} ]}^{T}$$
where xₑ and x_{b} are vehicle state information and control strategy information based on rule switching, respectively, Vₓ, V_{y} and \dot{ψ} are a longitudinal velocity, a lateral velocity and a yaw rate of an own vehicle in a vehicle coordinate system, respectively, (X, Y) and ψ are a center of mass position and a yaw angle of the own vehicle in a geodetic coordinate system, respectively, aₓ and a_{y} are a longitudinal acceleration and a lateral acceleration of the vehicle, respectively, M is a control mode of a rule-based controller corresponding to a current state, δ^{rule},
$${s}_{x 3}^{rule} , {s}_{x 4}^{rule}$$
are desired values of a front wheel steering angle, a left rear wheel longitudinal slip ratio and a right rear wheel longitudinal slip ratio output by the rule-based controller, respectively.

19. The method according to claim 18, wherein systematically integrating and modeling the multiple optimization indicators based on the reward function further comprises:
a preset action space comprising three elements:
$${A}_{r} = {[ {δ}_{d} , {s}_{x 3}^{d} , {s}_{x 4}^{d} ]}^{T}$$
where δ_{d} is a desired front wheel steering angle of an own vehicle,
$${s}_{x 3}^{d} and {s}_{x 4}^{d}$$
are a desired left rear wheel longitudinal slip ratio and a desired right rear wheel longitudinal slip ratio of the own vehicle.

20. The method according to claim 19, wherein systematically integrating and modeling the multiple optimization indicators based on the reward function further comprises:
obtaining an immediate reward Rᵣᵢ of the reward function;
wherein a path tracking term Rᵣᵢ₁ is defined as:
$${R}_{r i 1} = {k}_{r 1} \cdot \vert {e}_{Y} \vert + {k}_{r 2} \cdot \vert {e}_{φ} \vert$$
where e_{Y} is a deviation between an actual lateral displacement and a reference lateral displacement of the vehicle, e_{φ} is a deviation between an actual heading angle and a reference heading angle of the vehicle, kᵣ₁ and kᵣ₂ are negative constants, which are reward weights configured to adjust a lateral displacement deviation and a heading angle deviation, respectively;
a body stability term Rᵣᵢ₂ is defined as:
$${R}_{r i 2} = {k}_{r 3} \cdot ( \vert \dot{ψ} \vert + \vert β \vert )$$
where kᵣ₃ is a negative constant, which is a reward weight configured to adjust absolute value of a yaw rate 4 and a center of mass sideslip angle β;
a rollover risk term Rᵣᵢ₃ is defined as:
$${R}_{r i 3} = \{ \begin{matrix}0 & LTR \leq {LTR}_{t} \\ {k}_{r 4} \cdot ( LTR - {LTR}_{t} ) & LTR > {LTR}_{t}\end{matrix}$$
where LTRₜ is a safety threshold of a lateral load transfer ratio, kᵣ₄ is a negative constant, which is a reward weight configured to adjust the rollover risk term;
an input size and change rate term Rᵣᵢ₄ is defined as:
$${R}_{r i 4} = {k}_{r 5} \cdot ( {δ}^{2} + {s}_{x 3}^{2} + {s}_{x 4}^{2} ) + {k}_{r 6} \cdot ( {\dot{δ}}^{2} + {\dot{s}}_{x 3}^{2} + {\dot{s}}_{x 4}^{2} )$$
where kᵣ₅ and kᵣ₆ are negative constants, which are reward weights configured to adjust input items and change rates of the input items, respectively;
wherein the immediate reward Rᵣᵢ is a sum of the above items Rᵣᵢ₁ to Rᵣᵢ₄.

21. The method according to claim 20, further comprising obtaining a termination state reward Rᵣₜ of the reward function, which is formulated as:
$${R}_{r t} = \{ \begin{matrix}{k}_{r 7} & in case of occurrence of rollover \\ {R}_{rtc} & in case of completion of a control objective \\ {R}_{rtn} & in case of failure to complete the control objective until t = {t}_{end}\end{matrix}$$
$$where {k}_{r 7} is a negative constant .$$

22. The method according to claim 21, wherein an agent reward function Rᵣ is obtained based on the immediate reward Rᵣᵢ and the termination state reward Rᵣₜ, which is formulated as:
$${R}_{r} = {R}_{r i} + {R}_{rt} .$$
